(19) United States
(12) Patent Application Publication
(10) Pub. No.: US 2009/0141430 A1
(43) Pub. Date: Jun. 4, 2009

(54) Gas-Insulated Switchpanel of a Medium-Voltage Switchgear Assembly

(75) Inventors: Wolfgang Jung, Frankfurt (DE); Peter Schmitt, Offenbach (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/302,906

(22) PCT Filed: May 23, 2007
(86) PCT No.: PCT/EP2007/055003

§ 371 Date: Dec. 1, 2008

(30) Foreign Application Priority Data
May 29, 2006 (DE) 10 2006 025 650.6

(51) Int. Cl. H02B 1/20

(52) U.S. Cl. 361/612

(57) ABSTRACT

A gas-insulated switchpanel of a medium-voltage switchgear assembly includes busbar connection and cable outlet regions with a manually actuable switch arrangement having a contact position, with a conductive connection from the busbar connection region to the cable outlet region via the switch arrangement and a vacuum contactor, driven by a magnet, and a grounding position, in which the cable outlet region and the vacuum contactor are grounded by the switch arrangement. The vacuum contactor switches a current between the busbar connection region and the cable outlet region in the contact position and the switchpanel has a relatively high current-carrying capacity. The switch arrangement grounding and isolatinges switch mechanically coupled to one another and actuable by a single drive. In the contact position, the isolating switch forms the conductive connection and, in the grounding position, the grounding switch connects the vacuum contactor and the cable outlet region with a grounding contact.

The invention relates to a gas-insulated switchpanel of a medium-voltage switchgear assembly having a busbar connection region and a cable outlet region with a manually operated switch arrangement with a contact position in which a conductive connection is formed from the busbar connection region to the cable outlet region via the switch arrangement and a magnet-driven vacuum contactor switch, and a grounding position in which the cable outlet region and the vacuum contactor switch are grounded by the switch arrangement, with the vacuum contactor switch being provided to switch a current between the busbar connection region and the cable outlet region in the contact position of the switch arrangement.

A gas-insulated switchpanel of this type is known from the Siemens document “Siemens HA 35.41, 2005”. The gas-insulated switchpanel disclosed in said document has a busbar connection region and a cable outlet region, with a manually operated switch arrangement, in the form of a three-position load isolating switch, and a vacuum contactor switch being arranged between said regions. In this case, the three-position load isolating switch has a contact position in which the busbar connection region is connected to the cable outlet region in a conductive manner via the load isolating switch and the vacuum contactor. In this contact position of the three-position load isolating switch, the vacuum contactor is provided for switching a current between the busbar connection region and the cable outlet region. In this case, the vacuum contactor switch is a magnet-driven vacuum contactor switch, with the switchpanel being grounded by the three-position load isolating switch being moved to a grounding position in which a grounding contact of the switchpanel is connected to the vacuum contactor switch and the cable outlet region via the three-position load isolating switch and busbars. This arrangement ensures that grounding of the cable outlet region can be canceled only by manual operation of the three-position load isolating switch, and not, for example, by the loss of an auxiliary voltage for the magnet drive of the vacuum contactor switch.

The object of the present invention is to develop a gas-insulated switchpanel of the type mentioned in the introduction which has a higher current-carrying capacity.

According to the invention, this is achieved, in the case of a gas-insulated switchpanel of the type mentioned in the introduction, in that the switch arrangement comprises a grounding switch and an isolating switch which are mechanically coupled to one another and can be operated by means of a single drive, with the isolating switch forming the conductive connection in the contact position, and the grounding switch connecting the vacuum contactor and the cable outlet region by way of a grounding contact in the grounding position.

In the case of the gas-insulated switchpanel according to the invention, a current path is advantageously formed from the busbar connection region to the cable outlet region via the isolating switch and the vacuum contactor switch in the contact position of the switch arrangement, with the isolating switch having a high current-carrying capacity. In the contact position of the switch arrangement with the isolating switch in its connection position to the busbar connection region, the grounding switch is in its off position and therefore does not carry potential, whereas, in the grounding position, the isolating switch is disconnected from the busbar connection region and the grounding switch is moved to its grounding position by the manual operation of the switch arrangement, so that both the vacuum contactor switch and the cable outlet region are grounded in a make-proof manner via the grounding switch. A switch arrangement of this type in a gas-insulated switchpanel therefore advantageously has a high current-carrying capacity via the isolating switch and at the same time the option to provide make-proof grounding via the grounding switch.

In a preferred embodiment, the grounding switch is a load isolating switch with a moving switch blade for each phase of the switchpanel. A load isolating switch of this type as the grounding switch is advantageously suitable for make-proof grounding of the switchpanel because the load isolating switch is configured such that it can switch a grounding fault.

The invention will be explained in greater detail below using the drawing and an exemplary embodiment with reference to the enclosed figures, in which:

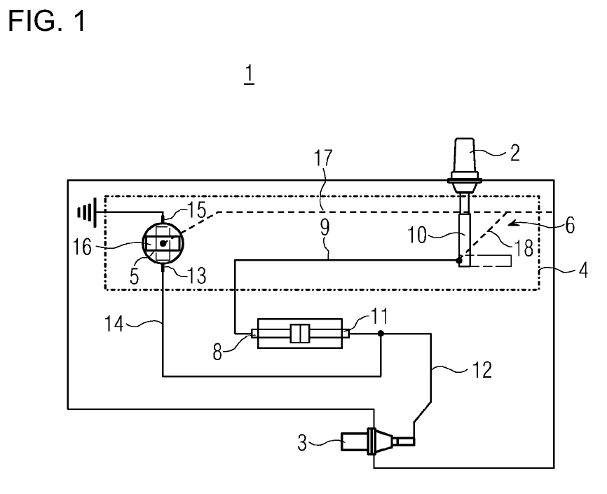

FIG. 1 shows a schematic illustration of a gas-insulated switchpanel according to the invention;

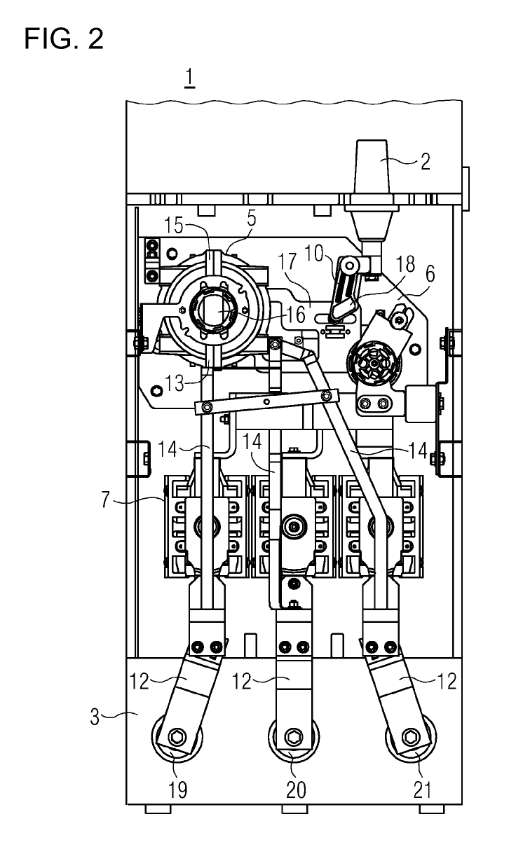

FIG. 2 shows a rear view of the gas-insulated switchpanel according to the invention of FIG. 1; and

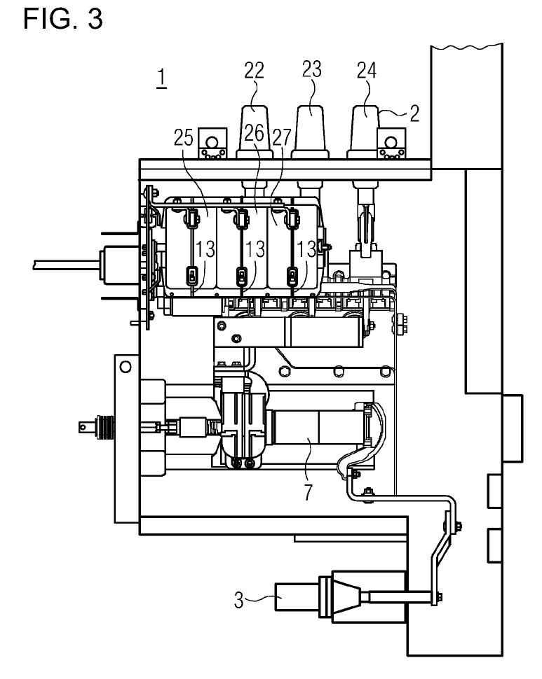

FIG. 3 shows a side view of the gas-insulated switchpanel according to the invention.

FIG. 1 shows a gas-insulated switchpanel 1 according to the invention having a busbar connection region 2, a cable outlet region 3 and a switch arrangement 4 which comprises a grounding switch 5 and an isolating switch 6. A vacuum contactor switch 7, which has a contact system with a fixed contact and a moving contact, with a magnet drive (not illustrated in the figures) being provided for operating the vacuum contactor switch 7, is arranged between the busbar connection region 2 and the cable outlet region 3 for the purpose of switching a current. The vacuum contactor is electrically conductively connected to a moving contact 10 of the isolating switch 6 via a first busbar 9 at a first contact 8, and a second contact 11 of the vacuum contactor switch 7 is conductively connected to the cable outlet region 3 of the switchpanel via a second busbar 12. A first connection 13 of the grounding switch 5 is likewise conductively connected to the second contact 11 of the vacuum contactor switch 7 and to the second busbar 12 and to the cable outlet region 3 via a third busbar 14. A second connection 15 of the grounding switch 5 is conductively connected to a part of the switchgear assembly which is at ground potential. The grounding switch 5 has a moving switch blade 16 which is mechanically coupled to a manually operated drive (not illustrated in the figures) via mechanical coupling means 17 which are schematically illustrated by dash-and-dot lines in FIG. 1. The moving contact 10 of the isolating switch 6 is mechanically coupled to the same manually operated drive via further mechanical coupling means 18.

FIG. 1 shows the switchpanel in a contact position of the switch arrangement 4, with the isolating switch 6, via its moving contact, forming a conductive connection between the busbar connection region 2 and the cable outlet region 3, which connection can be switched by means of the vacuum contactor switch 7, via the first busbars 9 and the vacuum contactor switch 7 by way of the second busbars 12. The grounding switch 5, by way of its moving switch blade 16, is located in a position in which no contact is made between the third busbars 14 and the grounding contact 15. In this case, the grounding switch 5 is in the form of a three-position load isolating switch according to the Siemens document “Siemens HA 35.41, 2005” and the isolating switch 6 is in the form of a three-position isolating switch according to the Siemens document “Siemens HA 35.41, 2005” which is hereby part of the current disclosure. The isolating switch 6 has a current-carrying capacity of up to 1250 A. If grounding of the switchpanel is required, the moving contact 10 of the isolating switch 6 is moved out of its contact position to a disconnected position by manual operation of the drive (not illustrated in the figures), with a rotary movement on the moving contact 10 being initiated by means of the mechanical coupling means 18. By virtue of the introduction of this movement, the moving switch blade 16 of the grounding switch 5 is moved to its grounding position by means of the mechanical coupling means 17, as a result of which the vacuum contactor 7 and the cable outlet region 3 are grounded via the third busbars 14. The switchpanel 1 is therefore grounded in a make-proof manner by the grounding switch 5 in its grounding position. In particular, a voltage drop across the magnet drive of the vacuum contactor switch 7 does not lead to any malfunction in the grounding of the switchpanel either because the vacuum contactor switch 7 is grounded via the third busbars 14.

FIG. 2 shows a rear view of the switchpanel 1 having the busbar connection region 2 and three phase connections 19, 20, 21 of the cable outlet region 3. The phase connections 19, 20 and 21 are conductively connected to the three-pole vacuum contactor switch 7 via the second busbars 12 and to the first connections 13 of the grounding switch 5 via the third busbars 14. The second connections 15 of the grounding switch 5 are conductively connected to a ground contact. The moving switch blade 16 of the grounding switch 5 is coupled via the mechanical coupling means 17 to a drive unit (not illustrated in the figures) for manual operation, with the moving contact 10 of the isolating switch 6 likewise being coupled to the drive mechanism via further coupling means 18.

FIG. 3 shows a side view of the switchpanel 1 having the three busbar connections 22, 23, 24 of the busbar connection region 2 and three switching chambers 25, 26, 27 of the load isolating switch, which chambers are situated one behind the other and each have a moving switch blade 16 and are each connected to the third busbars 14 at a first connection 13. The respective second connection 15 of the switching chambers 25, 26, 27 is conductively connected to the grounding contact of the switchpanel 1. The individual switching units (not shown in the figure) of the isolating switch 6 for the three phases of the current to be switched are arranged behind the switching chambers 25, 26 and 27 of the grounding switch 5, with the switching units of the isolating switch 6 conductively connecting in each case one of the busbar connections 22, 23, 24 to one of the poles of the three-pole vacuum contactor switch 7 in the contact position of the switch arrangement.

### LIST OF REFERENCE SYMBOLS

1 Switchpanel
2 Busbar connection region
3 Cable outlet region
4 Switch arrangement
5 Grounding switch
6 Isolating switch
7 Vacuum contactor switch
8 First contact
9 First busbar
10 Moving contact
11 Second contact
12 Second busbar
13 First connection
14 Third busbar
15 Second connection
16 Moving switch blade
17, 18 Mechanical coupling means
19, 20, 21 Phase connections
22, 23, 24 Busbar connections
25, 26, 27 Switching chambers

1-2. (canceled)

3. A gas-insulated switchpanel of a medium-voltage switchgear assembly, the switchpanel comprising:
a magnet-driven vacuum contactor switch;
a busbar connection region and a cable outlet region with a manually operated switch configuration having a contact position and a grounding position;
said switch configuration forming a conductive connection from said busbar connection region to said cable outlet region through said the switch configuration and said magnet-driven vacuum contactor switch in said contact position;
said switch configuration grounding said cable outlet region and said vacuum contactor switch in said grounding position;
said vacuum contactor switch switching a current between said busbar connection region and said cable outlet region in said contact position of said switch configuration;
said switch configuration including a grounding switch and an isolating switch being mechanically coupled to one another and configured to be operated by a single drive; and
said isolating switch forming said conductive connection in said contact position, and said grounding switch having a grounding contact connecting said vacuum contactor and said cable outlet region in said grounding position.

4. The gas-insulated switchpanel according to claim 3, wherein said grounding switch is a load isolating switch with a moving switch blade for each phase of the switchpanel.
